(19) United States
(12) Patent Application Publication
(10) Pub. No.: US 2013/0067758 A1
(43) Pub. Date: Mar. 21, 2013

(54) MODULAR WALL PANELS AND SYSTEMS

(71) Applicants: Clayton Fearon, Mississauga (CA); Kenneth Jeans, Milton (CA); Robert Kenneth Smith, Ancaster (CA); Rodolfo Morrone, Toronto (CA)

(72) Inventors: Clayton Fearon, Mississauga (CA); Kenneth Jeans, Milton (CA); Robert Kenneth Smith, Ancaster (CA); Rodolfo Morrone, Toronto (CA)

(73) Assignee: AGT PRODUCTS (IP) INC., Mississauga (CA)

(21) Appl. No.: 13/617,927

(22) Filed: Sep. 14, 2012

(30) Foreign Application Priority Data
Sep. 14, 2011 (CA) 2752021

(51) Int. Cl. E04B 2/02; E04C 2/284; G01B 1/00; E04C 2/52

(52) U.S. Cl. 33/528; 52/782.1; 52/588.1; 52/220.1; 52/126.3

(57) ABSTRACT

Wall systems according to certain embodiments of the present invention provide a means for finishing interior walls such as basement walls. In certain embodiments of the present invention, wall panels offer several options for light switches, plug outlets, cable outlets, communication box outlets and the like. In other embodiments of the present invention, wall panels are provided with a means for eliminating or reducing the need for taping and filling that is used in conventional drywall finishing.

### TECHNICAL FIELD

The invention generally relates to wall panels and systems.

### BACKGROUND

A typical basement has perimeter walls of poured concrete or blocks which line a hole or cavity excavated into a ground surface and which acts as a foundation for a home or other structure supported thereby.

Typical perimeter walls are built with load bearing rather than aesthetic aspects in mind and accordingly tend to be somewhat irregular and are generally uninsulated. In order to finish a basement, the foregoing aspects must be dealt with.

The typical way to finish a basement is to erect “studs” (vertical wooden members) typically spaced 16 inches apart along the interior face of the perimeter walls. Insulation of some form (e.g. Styrofoam™ or fibreglass) is inserted in the channels defined by the wall and the adjacent studs. A suitable vapour barrier is placed over the insulation if required and “drywall” (gypsum wallboard) sheets are secured to the studs over the insulation and vapour barrier.

The “finishing” of a typical basement using the prior system is labour and time intensive. Typically upper and lower framing members would be installed adjacent respectively the ceiling joist and a floor. Studs would be mounted between the upper and lower members. The insulation would be cut and installed. The drywall sheets would be cut and secured and finally joints between the drywall sheets would be taped and filled with drywall compound for subsequent sanding and final finishing.

In addition to the above steps, accommodation must be made for electrical sockets and switches. Such would typically be mounted in boxes secured to the studs and serviced by wiring also secured to the studs. Once the boxes have been installed, a challenge is presented to one installing drywall sheets over the boxes in that the location of the boxes has to be carefully measured and translated to the drywall sheet in order to cut suitable openings to accommodate the boxes.

### SUMMARY

In one or more embodiments, the present invention relates to wall systems which provide a means for finishing interior walls, such as basement walls. In certain embodiments of the present invention, wall panels offer several options for light switches, plug outlets, cable outlets and communication box outlets. In other embodiments of the present invention, wall panels are provided with a means for eliminating or reducing the need for taping and filling that is used in conventional drywall finishing.

Wall systems according to the present invention are modular.

In one or more embodiments, the present invention relates to a modular wall panel including a sheet of material suitable for forming at least part of an interior wall, the sheet having an outer face and an inner face; a layer of insulation secured to the sheet on the inner face; and connectors for connecting the panel to one or two other panels. In certain embodiments, the panel may further include at least two framing members. In certain embodiments, connectors may be provided in the framing members. Suitable connectors include but are not limited to tongue and groove and click lock connectors. In certain embodiments, one or more conduits for wiring may be provided in the panel. Suitable conduits include tubes such as PVC tubes. In certain embodiments, the conduits may be located in the insulation of the panel. In certain embodiments, the conduits are housed in channels in the insulation. In certain embodiments, channels formed in the insulation may serve as conduits. In certain embodiments, the panel may further comprise an electrical or communications outlet. In certain embodiments, the panel may comprise one or more bevels formed in one or more edges of the panel. In certain embodiments, the panel includes one or more level bubbles in one or more directions. In certain embodiments, the panel may be a door header panel, a light switch panel, an outlet or cable panel or a plain wall panel. In certain embodiments, two or more panels can be connected together to form a interior wall or part thereof. In certain embodiments, two or more panels are connected together to form a modular wall system.

In another embodiment, the present invention relates to a template comprising a plate including an opening in the plate for tracing the outline of an opening for a well in a modular wall panel; and a flange at one end of the plate and in a plane perpendicular to the plane of the plate.

### DESCRIPTION OF DRAWINGS

Embodiments of the present invention are described below with reference to the accompanying illustrations in which:

FIG. 1 is a front view of a panel according to an embodiment of the present invention;

FIG. 2 is a cross section taken along line A-A of FIG. 1;

FIG. 3 is a rear view of the panel of FIG. 1 with insulation not shown;

FIG. 4 is a cross section taken along line B-B of FIG. 3;

FIG. 5 is front view of a panel according to another embodiment of the present invention;

FIG. 6 is a cross section taken along line A-A of FIG. 5;

FIG. 7 is a rear view of the panel of FIG. 5 with insulation not shown;

FIG. 8 is a cross section taken along line B-B of FIG. 7;

FIG. 9 is front view of a panel according to another embodiment of the present invention;

FIG. 10 is a cross section taken along line A-A of FIG. 9;

FIG. 11 is a rear view of the panel of FIG. 9 with insulation not shown;

FIG. 12 is a cross section taken along line B-B of FIG. 11;

FIG. 13 is front view of a panel according to another embodiment of the present invention;

FIG. 14 is a cross section taken along line A-A of FIG. 13;

FIG. 15 is a rear view of the panel of FIG. 13 with insulation not shown;

FIG. 16 is a cross section taken along line B-B of FIG. 15;

FIG. 17 is front view of a panel according to another embodiment of the present invention;

FIG. 18 is a cross section taken along line A-A of FIG. 17;

FIG. 19 is a rear view of the panel of FIG. 17 with insulation not shown;

FIG. 20 is a cross section taken along line B-B of FIG. 19;

FIG. 21 is front view of a panel according to another embodiment of the present invention;

FIG. 22 is a cross section taken along line A-A of FIG. 21;

FIG. 23 is a rear view of the panel of FIG. 21;

FIG. 24 is a cross section taken along line B-B of FIG. 23;

FIG. 25 is a side view of a sheet of material suitable for forming an interior wall according to an embodiment of the present invention;

FIG. 26 is a side view of part of two sheets of wall finishing material according to an embodiment of the present invention jointed together;

FIG. 27 is a side view of a template according to an embodiment of the present invention;

FIG. 28 is a top view of the template of FIG. 27;

FIG. 29 is a front view of a panel according to the present invention showing the template of FIG. 27 in use;

FIG. 30 is a front view of a wall installation of panels according to one or more embodiments of the present invention;

FIG. 31 is a side view of the installation of FIG. 30;

FIG. 32 is a side view of a panel according to the present invention;

FIG. 33 is a side view of a panel according to the present invention;

FIG. 34 is a side view of a panel according to the present invention; and

FIG. 35 is a top view of a panel according to the present invention.

### DETAILED DESCRIPTION

A modular wall panel according to one embodiment of the present invention is generally illustrated by reference 2.

The panel 2, also referred to as a “light switch panel” if a light switch installed in the panel, is comprised of a sheet 4 of medium-density fiberboard (“MDF”) having an outer wall finishing surface 6 and an interior surface 8. The sheet 4 is 14 inches wide and 96 inches high but may be of other dimensions depending upon the application. The sheet 4 may be made of other material suitable for forming an interior wall, such as but not limited to gypsum wallboard, shiplap, HDF, OSB, fibre cement board and drywall. The wall finishing surface 6 is one which is suitable for accepting wall finishes such as wallpaper and paint. The surface 6 may be pre-primed such that once installed, it can be painted without further priming.

Two framing members 10 and 12 are secured to the panel on the interior surface 8 side of the sheet 4. The framing members 10 and 12 may be secured to the sheet 4 by suitable adhesives or fasteners. The framing members 10 and 12 are at or near the edges of the sheet 4 but may be located at other locations on the sheet 4 provided that the sheet 4 is provided with a sufficient amount of structural integrity. The framing members 10 and 12 are 2′×3′ wood lumber and extend from the top 26 of the sheet 4 to near the bottom edge 27 of the sheet 4. Recesses 29 are provided between the end of the framing members 10 and 12 and the bottom edge 27 to receive a cleat when the panel 2 is installed on joists provided with a cleat. Recesses 29 are optional and the framing members 10 and 12 may extend to the bottom edge 27. The framing members 10 and 12 may be of other dimensions and may be made from other suitable materials such as wood-plastic composite materials, metals, alloys and plastics that provide sufficient structural integrity to the sheet 4. The framing member 10 is provided with a groove 14 while the framing member 12 is provided with a tongue 16. The groove 14 is for receiving a tongue from another panel while the tongue 16 is designed to be received by a groove in another panel when more than one panel 2 is joined together to form an interior wall or part of an interior wall. Instead of tongue and groove, other suitable connectors, such as a click-lock system, may be provided in the panel 2 for connecting panel 2 to one or more other panels.

In order to provide electrical or communications service to the panel 2, a box 18 is provided for housing an electrical or communications outlet (not shown). The electrical or communications outlet includes an electrical outlet, electrical switch, cable box, telephone jack, internet jack, and the like. An opening 20 in the sheet 4 provides access to the box 18. The box 18 is located in the panel 2 such that upon installation of the panel 2, the box 18 is at approximately the standard height from the floor that is typical for that type of box. The box 18, in other embodiments, may be located elsewhere in the panel 2 such that when panel 2 is installed, the box 18 is located at a non-standard height above the floor. In other embodiments the horizontal position of the box 18 in the panel 2 may vary. A tube conduit 22 extends from an opening 24 in the box 18 to the top edge 26 of the panel 2. The conduit 22 allows for the installation of wiring for wiring an electrical or communications outlet housed in the box 18. The conduit 22 can be made of PVC or other suitable material.

Insulation can be placed in the area between the framing members 10 and 12 and around the box 18 and conduit 22 and secured to the sheet 4 and/or the members 10 and 12 by suitable means such as adhesives and fasteners. The insulation can be any insulation suitable for residential or commercial construction to insulate. Examples of insulation which can be used include sheet foam insulation (for example be of Styrofoam™) and fibre glass insulation (for example Fiberglass Pink™). In certain embodiments, the insulation may be secured to the sheet 4 and/or to the members 10 and 12 and/or retained in place by other suitable means such as by a sheet of plastic vapour barrier material, (not shown) or other suitable material secured to the back side of the panel.

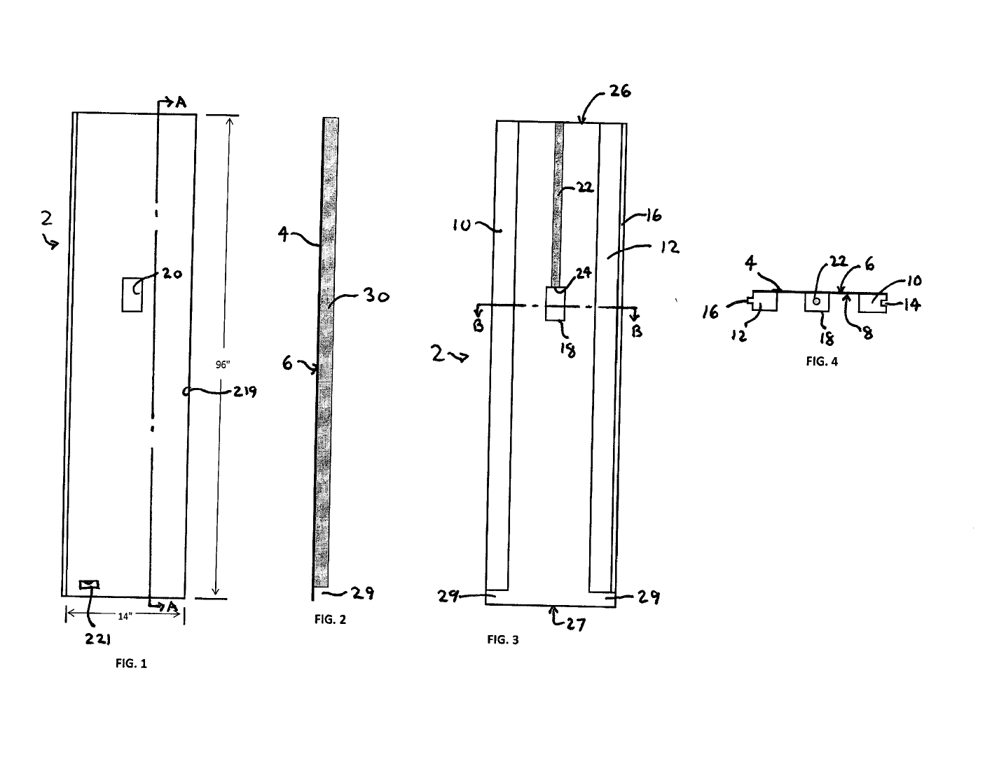

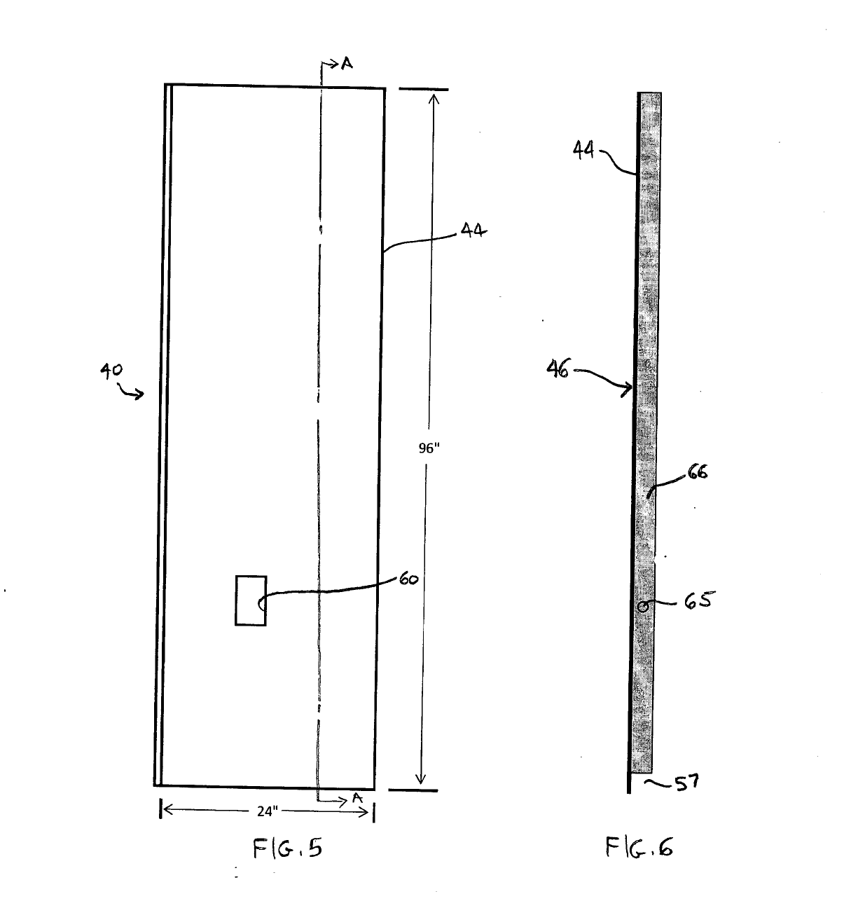

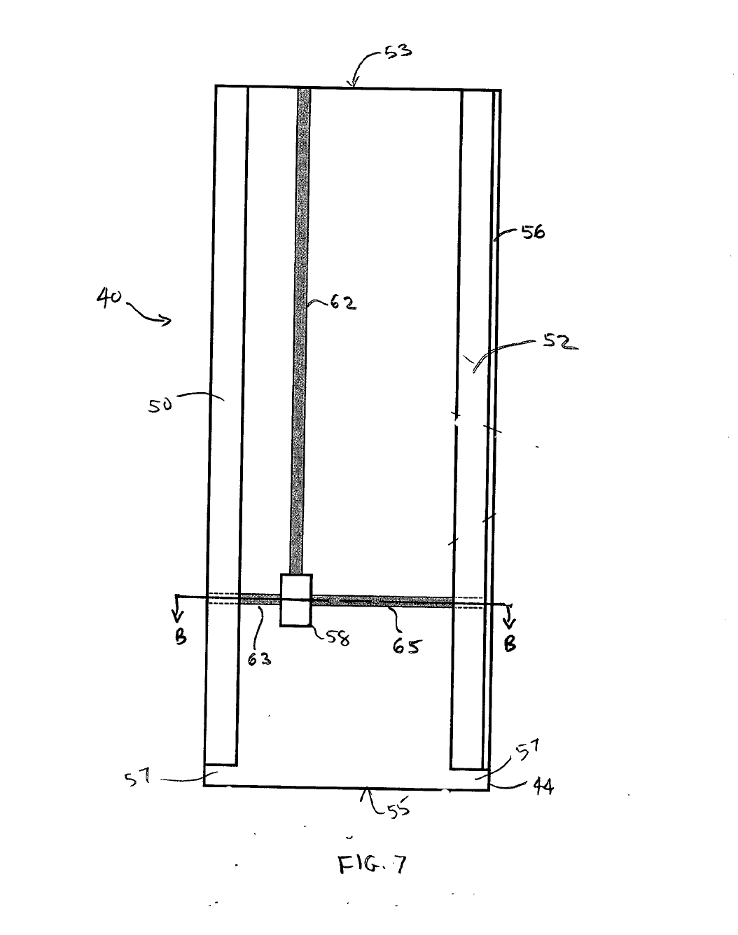

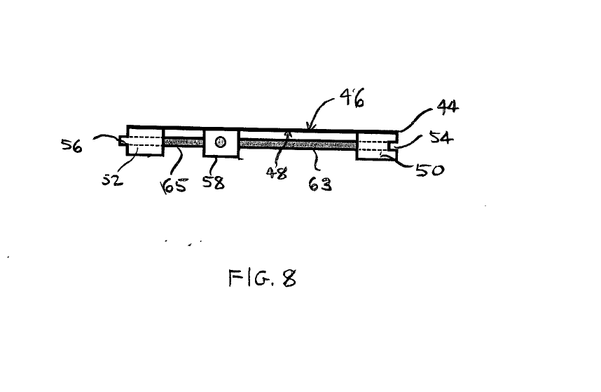

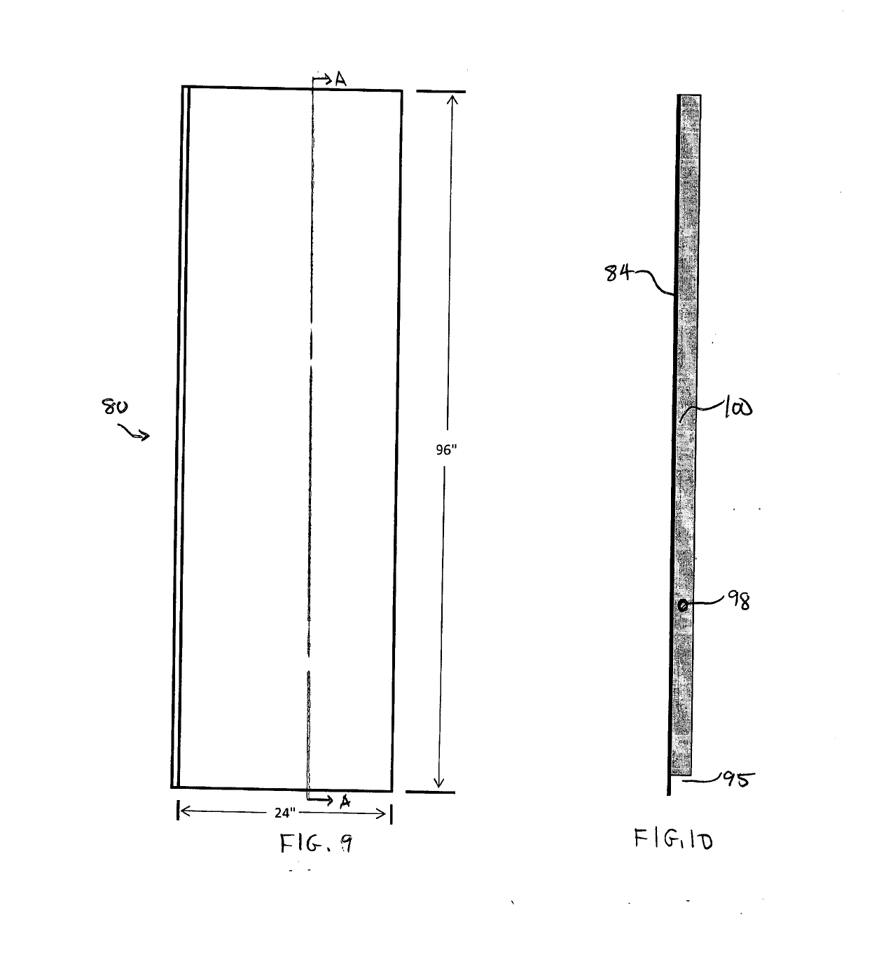

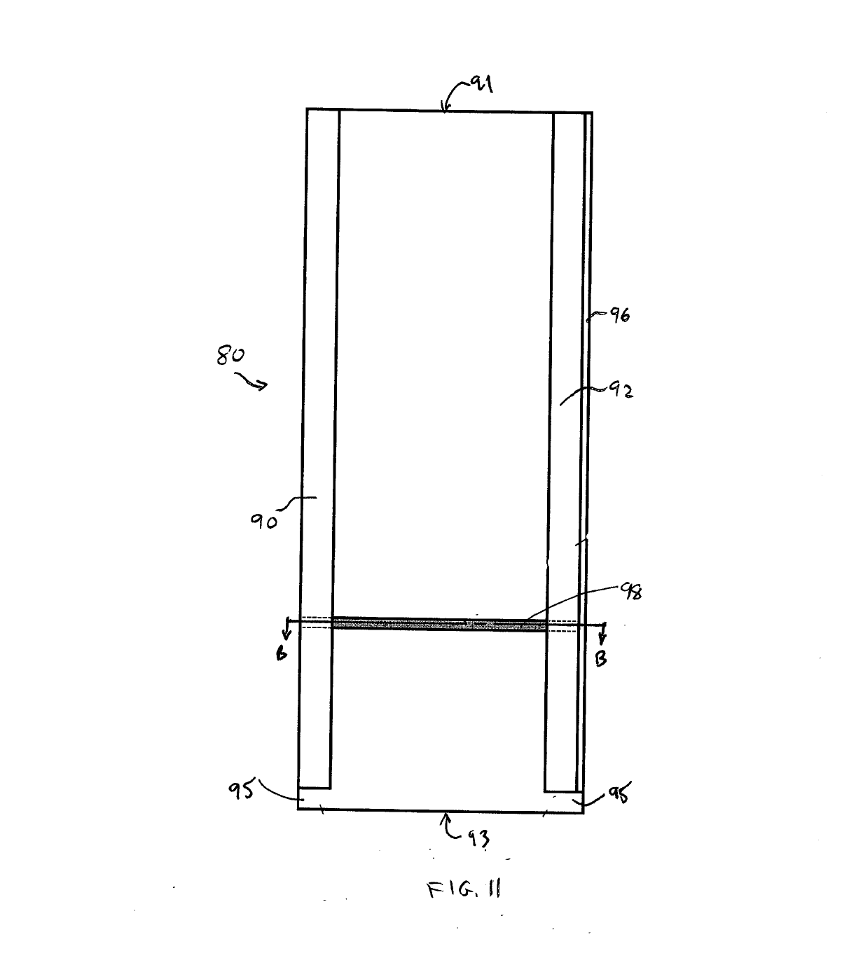

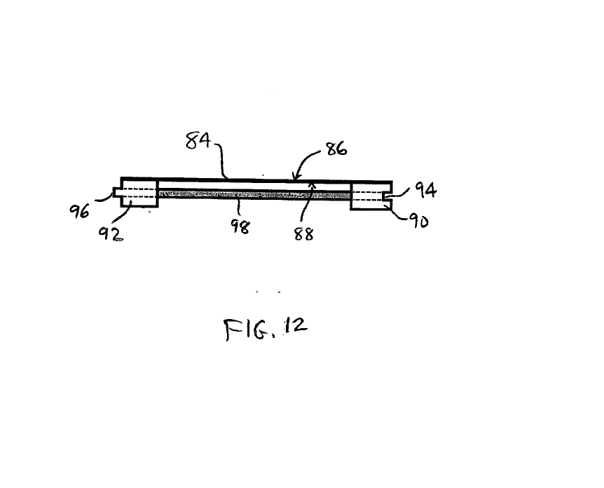

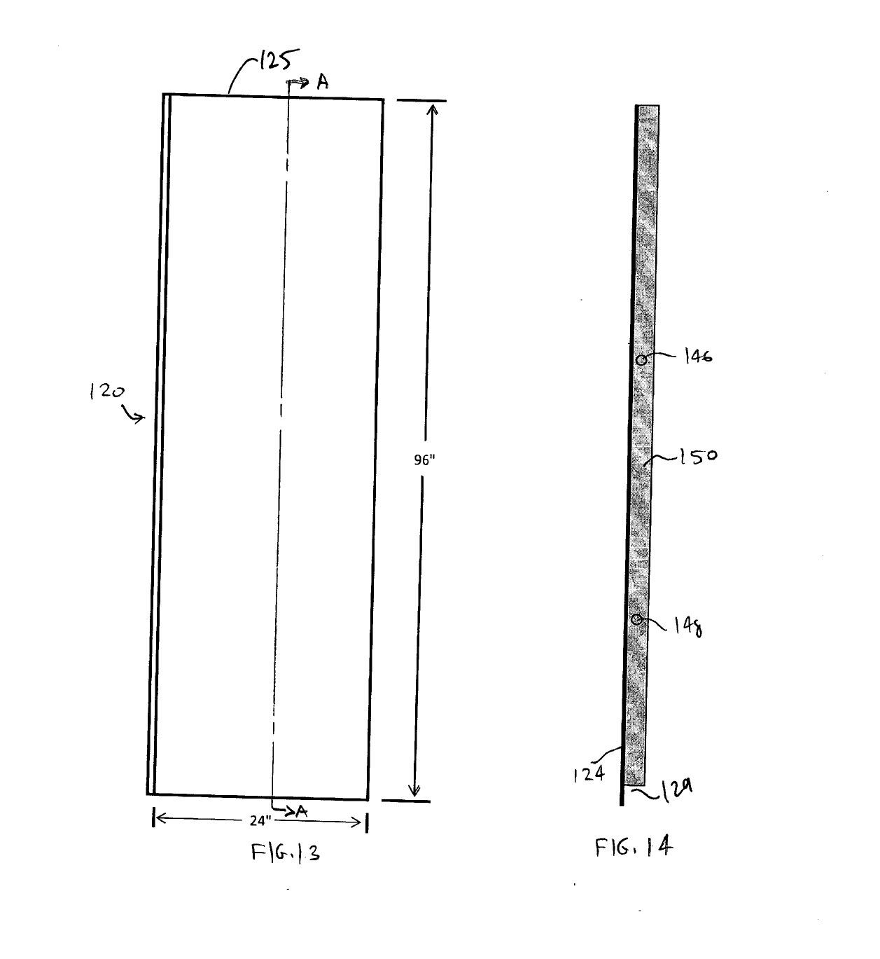

In another embodiment, in the panel 2, the box 18 and the conduit 22 can be housed in sheet foam insulation 30. FIG. 2 is a cross section taken along line A-A of FIG. 1 of another embodiment (with insulation 30) of the panel 2 of FIG. 1 (panel 2 in FIGS. 1, 3 and 4 is shown without insulation). The insulation 30 may cover all or part of the area of the sheet 4. In such an embodiment, a well (not shown) is provided in the sheet insulation to house the box 18. A channel (not shown) is provided in the foam insulation to house the conduit 22. In a further embodiment, the tube conduit 22 can be omitted and a channel in the insulation 30 can serve as a conduit for wiring. In a still further embodiment, the well in the sheet of insulation is omitted. In such an embodiment, an opening in the sheet 4 and a well in the insulation 30 may be cut such that the cut well is in communication with the conduit 22. An electrical or communications box may then be inserted into the well. In a still further embodiment, the sheet 4 may be omitted

The incorporation of an electrical outlet box 18 with an electrical conduit 22 in panel 2 facilitates the installation of electrical or communication services in a finishing operation such as in a basement. Previously, electrical outlet and cable would have been secured to studs prior to placement of drywall over the studs. This proved challenging in guessing with any degree of accuracy where to place a hole in the overlying drywall sheet so as to correspond with the electrical or communications outlet.

A wall panel according to another embodiment of the present invention is illustrated by reference 40. The panel 40 is also referred to as an “outlet or cable panel” if an outlet or cable box is installed in the panel. The panel 40 is comprised of a sheet 44 of MDF having an outer wall finishing surface 46 and an interior surface 48. The sheet 44 is 24″ wide and 96″ high but may be of other dimensions depending upon the application. The sheet 44 may be made of other material suitable for forming an interior wall, such as gypsum but not limited to wallboard, shiplap, HDF, OSB, fibre cement board and drywall. The wall finishing surface 46 is one which is suitable for accepting wall finishes such as wallpaper and paint. The surface 46 may be pre-primed such that once installed, it can be painted without further priming.

Two framing members 50 and 52 are secured to the panel on the interior surface 8. The framing members 50 and 52 may be secured to the sheet 40 by suitable adhesives or fasteners. The framing members 50 and 52 are at or near the edges of the sheet 44 but may be located at other locations on the sheet 44 provided that the sheet 44 is provided with a sufficient amount of structural integrity. The framing members 50 and 52 are 2′×3′ wood lumber and extend from the top 53 of the sheet 44 to near the bottom edge 55 of the sheet 44. Recesses 57 are provided between the end of the framing members 50 and 52 and the bottom edge 55 to receive a cleat when the panel 40 is installed on joists provided with a cleat. Recesses 57 are optional and the framing members 50 and 52 may extend to the bottom edge 55. The framing members 50 and 52 may be of other dimensions and may be made from other suitable materials such as wood-plastic composite materials, metals, alloys and plastics that provide sufficient structural integrity to the panel 40. The framing member 50 is provided with a groove 54 while the framing member 52 is provided with a tongue 56. The groove 54 is for receiving a tongue from another panel while the tongue 56 is designed to be received by a groove in another panel when more than one panel 40 is joined together to form a wall or part of a wall. Instead of tongue and groove, other suitable connectors, such as a click-lock system, may be provided in the framing members 50 and 52 for connecting panel 40 to one or more other panels.

In order to provide electrical or communications service to the panel 40, a box 58 is provided for housing an electrical or communications outlet (not shown). The electrical or communications outlet includes an electrical outlet, electrical switch, cable box, telephone jack, internet jack, and the like. An opening 60 in the sheet 50 provides access to the box 58. The box 58 is located in the panel 40 such that upon installation of the panel 40, the box 58 is at approximately the standard height from the floor that is typical for that type of box. The box 58 in other embodiments may be located elsewhere in the panel 40 such that when the panel 40 is installed, the box 58 is located at a non-standard height above the floor. In other embodiments, the horizontal position of the box 58 in the panel 40 may vary. A tube conduit 62 extends from an opening 64 in the box 58 to the top 66 of the panel 40. A second conduit 63 extends horizontally from the box 58 and through the member 50. A third conduit 65 extends horizontally from the box 28 and through the member 52. The conduits 62, 63 and 65 allow for the installation of wiring for wiring an electrical or communications outlet housed in the box 58. The conduits 62, 63 and 65 may be made of PVC or other suitable material.

Insulation can be placed in the area between the framing members 50 and 52 and around the box 58 and conduits 62, 63 and 65 and secured to the sheet 40 and/or the members 50 and 52 by suitable means such as adhesives and fasteners. The insulation can be any insulation suitable for residential or commercial construction. Examples of insulation which can be used include sheet foam insulation (for example be of Styrofoam™) and fibre glass insulation (for example Fiberglass Pink™). In certain embodiments, the insulation may be secured to the sheet 44 and/or to the members 50 and 52 and/or retained in place by other suitable means such as a sheet of plastic vapour barrier material secured to the back side of the panel 40.

In another embodiment, in the panel 40, the box 58 and the conduits 62, 63 and 65 can be housed in a sheet of foam insulation 66. FIG. 6 is a cross section taken along line A-A of FIG. 5 but with insulation 66 included. Panel 40 is shown in FIGS. 5, 7 and 8 without insulation 66. The insulation 66 may cover all or part of the area of the sheet 44. In such an embodiment, a well (not shown) is provided in the sheet insulation 66 to house the box 18. Channels are provided in the sheet insulation 66 to house conduits 62, 63 and 65. In a further embodiment, the conduits 62, 63 and 65 can be omitted and the channels themselves can serve as the conduits for wiring. In a still further embodiment, the well in the sheet of insulation 66 is omitted. In such an embodiment, an opening in the sheet 44 and a well in the insulation 66 may be cut such that the cut well is in communication with one or more of the conduits 62, 63 and 65. An electrical or communications box may then be inserted into the well. In a still further embodiment, the sheet 44 may be omitted.

A modular wall panel according to another embodiment of the present invention is generally illustrated by reference 80. The panel 80 is also referred to as a “plain wall panel”. The panel 80 is comprised of a sheet MDF having an outer wall finishing surface 86 and an interior surface 88. The sheet 84 is 14 inches wide and 96 inches high but may be of other dimensions depending upon the application. The sheet 84 may be made of other suitable material for forming an interior wall such as but not limited to gypsum wallboard, shiplap, HDF, OSB, fibre cement board or drywall. The wall finishing surface 86 is one which is suitable for accepting wall finishes such as wallpaper and paint. The surface 86 may be pre-primed such that once installed, it can be painted without further priming.

Two framing members 90 and 92 are secured to the panel on the interior surface 88. The framing members 90 and 92 are secured to the panel 40 on the interior surface 88 side of sheet 84 by suitable adhesives or fasteners. The framing members 90 and 92 are at or near the edges of the sheet 84 but may be located at other locations on the sheet 84 provided that the sheet 84 is provided with sufficient amount of structural integrity. The framing members 90 and 92 are 2′×3′ wood lumber and extend from the top 91 of the sheet 84 to near the bottom 93 of the sheet 84. Recesses 95 are provided between the end of the framing members 90 and 92 and the bottom edge 93 to receive a cleat when the panel 80 is installed on joists provided with a cleat. Recesses 95 are optional and the framing members 90 and 92 may extend to the bottom edge 93. The framing members may be of other dimensions and may be made from other suitable materials such as wood-plastic composite materials, metals, alloys and plastics that provide sufficient structural integrity to the panel 80. The framing member 90 is provided with a groove 94 while the framing member 92 is provided with a tongue 96. The groove 94 is for receiving a tongue from another panel while the tongue 96 is designed to be received by a groove in another panel when more than one panel 80 is joined together to form a wall or part of a wall. Instead of tongue and groove, other suitable connectors, such as a click-lock system, may be provided in the framing members 80 and 82 for connecting panel 80 to one or more other panels.

In order to allow wiring to pass through the panel, the panel 80 is provided with a conduit tube 98 which extends through the members 90 and 92. The conduit 98 can be made of PVC or other suitable material.

Insulation can be placed in the area between the framing members 90 and 92 and around the conduit 98 and secured to the sheet 84 and/or the members 90 and 92 by suitable means such as adhesives and fasteners. The insulation can be any insulation suitable for residential or commercial construction. Examples of insulation which can be used include sheet foam insulation (for example be of Styrofoam™) and fibre glass insulation (for example Fiberglass Pink™). In certain embodiments, the insulation may be secured to the sheet 84 and/or to the members 90 and 92 and/or retained in place by a sheet of plastic vapour barrior material or other suitable material secured to the back side of the panel.

In another embodiment, in the panel 80, the conduit 98 can be housed in a sheet of foam insulation 100. FIG. 10 is a cross section taken along line A-A of FIG. 9 but with insulation 100 included. Panel 80 is shown in FIGS. 9, 11 and 12 without insulation 100. The insulation 100 may cover all or part of the area of the sheet 84. In such an embodiment, a channel is provided in the foam insulation to house the conduit 98. In a further embodiment, the conduit 98 can be omitted and a channel in the insulation 100 may serve as a conduit for wiring.

The incorporation of a conduit 98 in panel 80 facilitates the installation of electrical or communication services in a finishing operation such as in a basement.

A modular wall panel according to another embodiment of the present invention is generally illustrated by reference 120.

The panel 120 is comprised of a sheet 124 of MDF having an outer wall finishing surface 126 and an interior surface 128. The sheet 124 is 24 inches wide and 96 inches high but may be of other dimensions depending upon the application. The sheet 124 may be made of other suitable material for forming an interior wall such as such as but not limited to gypsum wallboard, shiplap, HDF, OSB, fibre cement board or drywall. gypsum wallboard and drywall. The wall finishing surface 126 is one which is suitable for accepting wall finishes such as wallpaper and paint. The surface 126 may be pre-primed such that once installed, it can be painted without further priming.

Two framing members 130 and 132 are secured to the panel on the interior surface 128 side of the sheet 124. The framing members 130 and 132 may be secured to the sheet 124 by suitable adhesives or fasteners. The framing members 130 and 132 are at or near the edges of the sheet 124 but may be located at other locations on the sheet 124 provided that the sheet 124 is provided with sufficient amount of structural integrity. The framing members 130 and 132 are 2′×3′ wood lumber and extend from the top edge 125 of the sheet 124 to near the bottom edge 127. Recesses 129 are provided between the framing members 130 and 132 and the bottom edge 127 to receive a cleat when the panel 120 is installed on joists provided with a cleat. Recesses 129 are optional and framing members 130 and 132 may extend to the bottom edge 127. The framing members 130 and 132 may be of other dimensions and may be made from other suitable materials such as wood-plastic composite materials, metals, alloys and plastics that provide sufficient structural integrity to the panel 120. The framing member 130 is provided with a groove 134 while the framing member 132 is provided with a tongue 136. The groove 134 is for receiving a tongue from another panel while the tongue 136 is designed to be received by a groove in another panel when one or more panel 120 (or other panels according to the present invention) is joined together to form a wall or part of a wall. Instead of tongue and groove, other suitable connectors, such as a click-lock system, may be provided in the framing members 130 and 132 for connecting panel 120 to one or more other panels.

In order to provide electrical or communications service to or through the panel 122, two horizontal conduits 142 and 144 and two vertical conduits 146 and 148 are provided. The conduits 146 and 148 are PVC tubes but may be made of other suitable materials.

Insulation can be placed in the area between the framing members 130 and 132 and around the conduits 146 and 148 and secured to the sheet 124 and/or the members 130 and 132 by suitable means such as adhesives and fasteners. The insulation can be any insulation suitable for residential or commercial construction. Examples of insulation which can be used include sheet foam insulation (for example be of Styrofoam™) and fibre glass insulation (for example Fiberglass Pink™). In certain embodiments, the insulation may be secured to the sheet 124 and/or to the members 130 and 132 and/or retained in place by a sheet of plastic vapour barrier material or other suitable material secured to the back side of the panel.

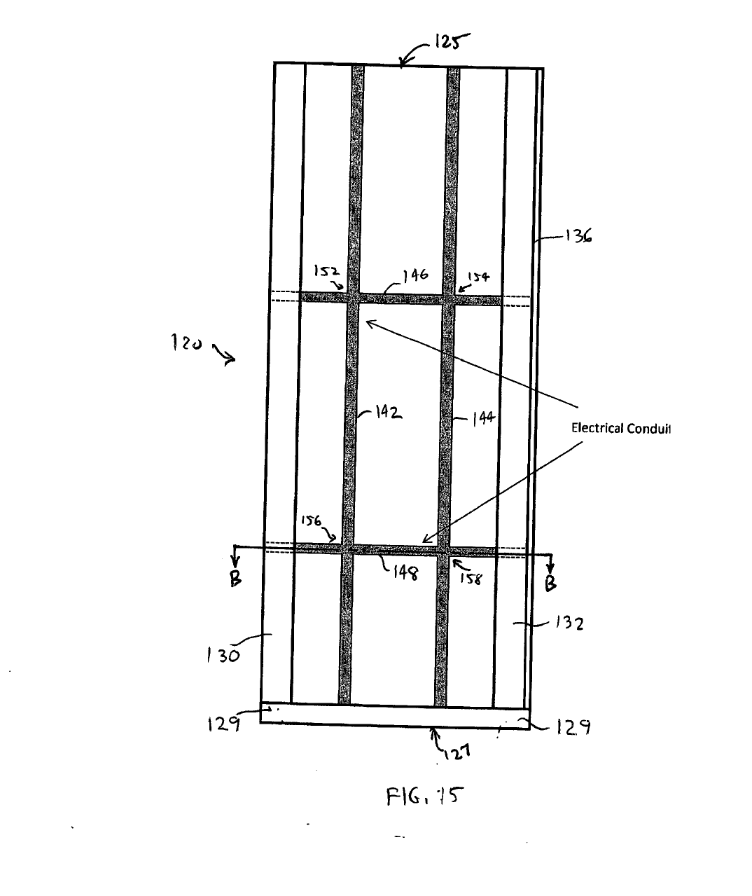

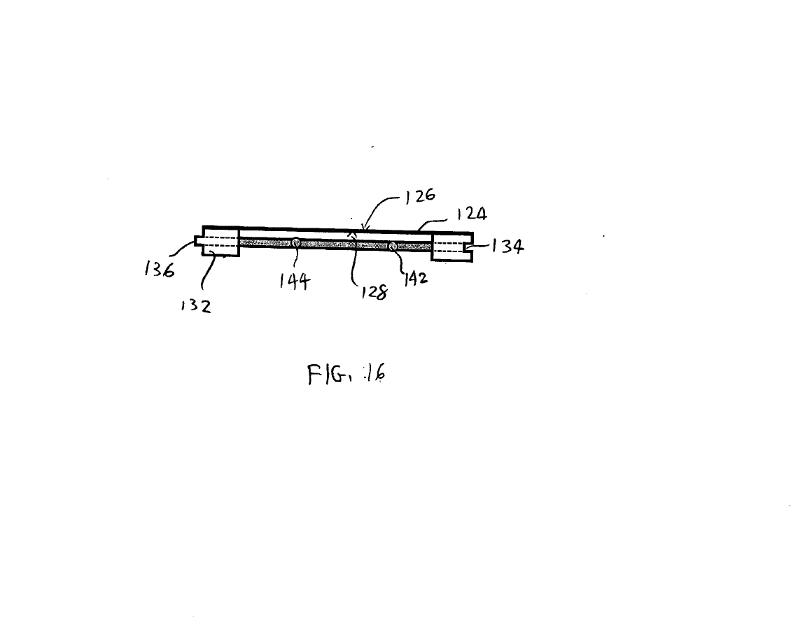

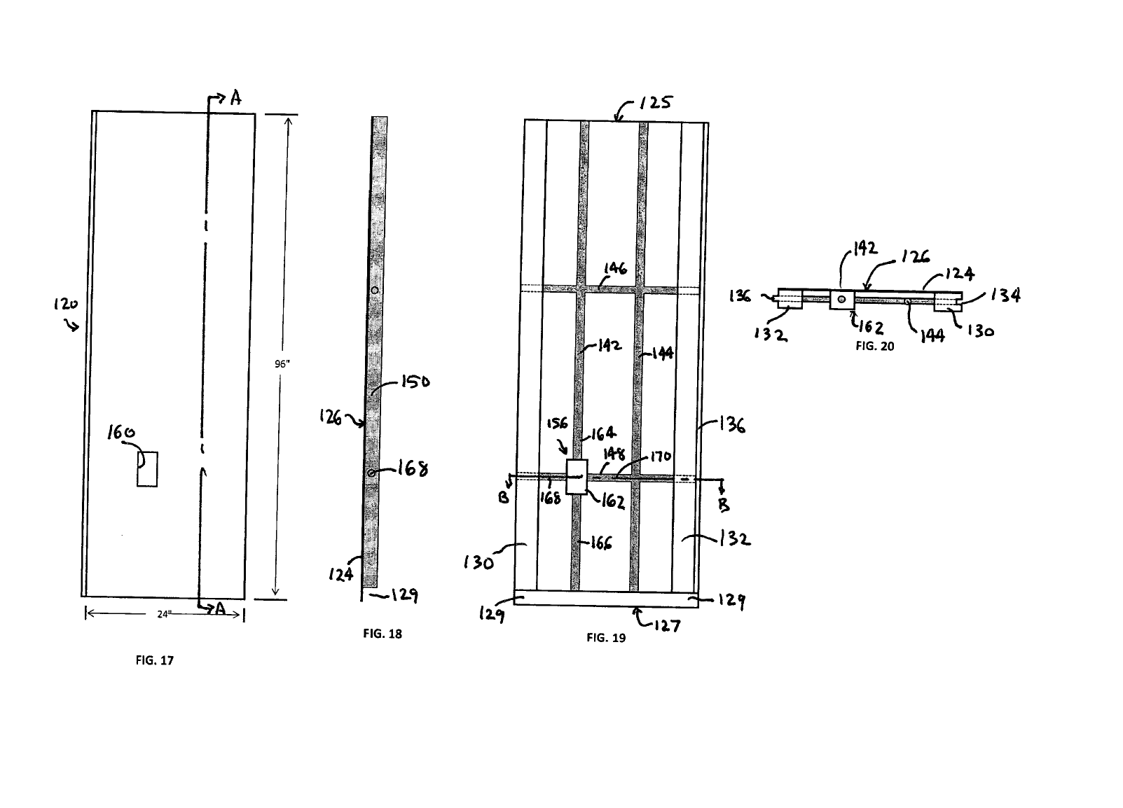

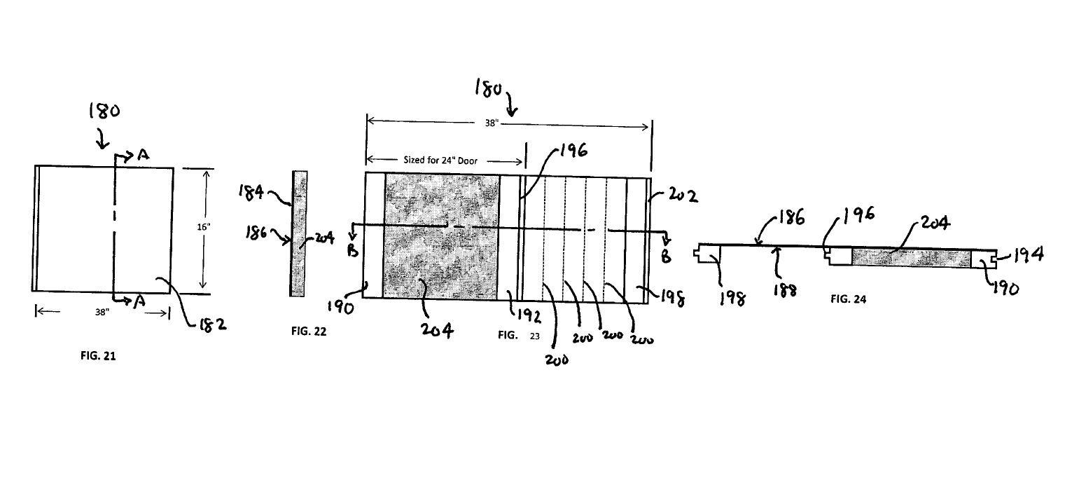

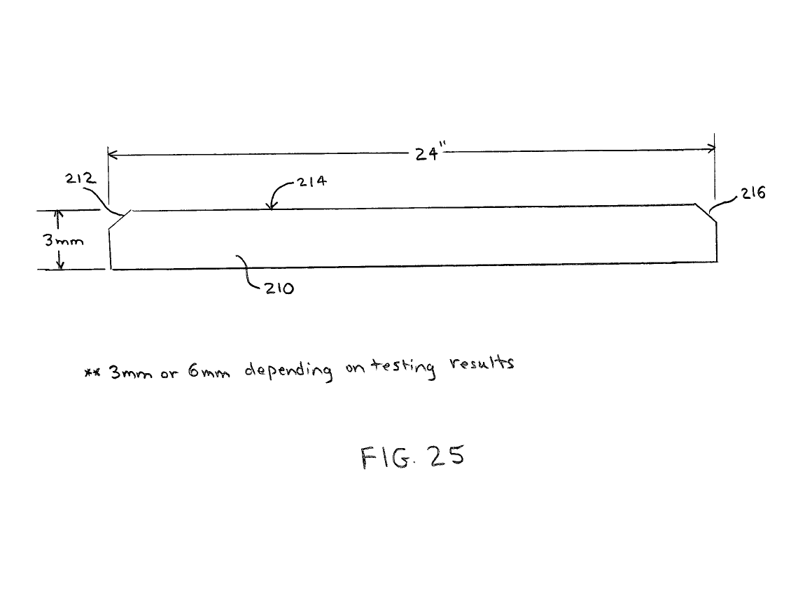

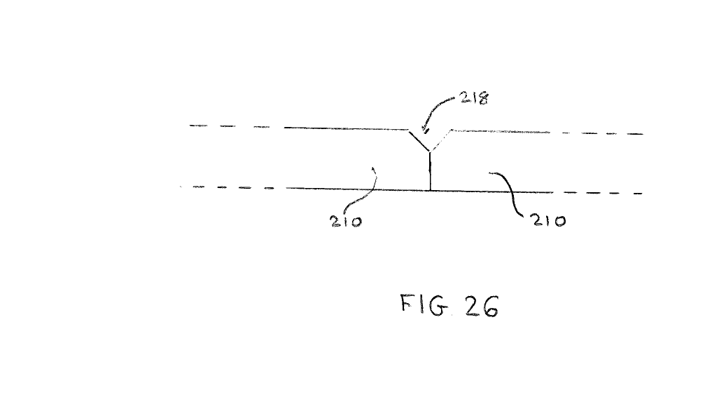

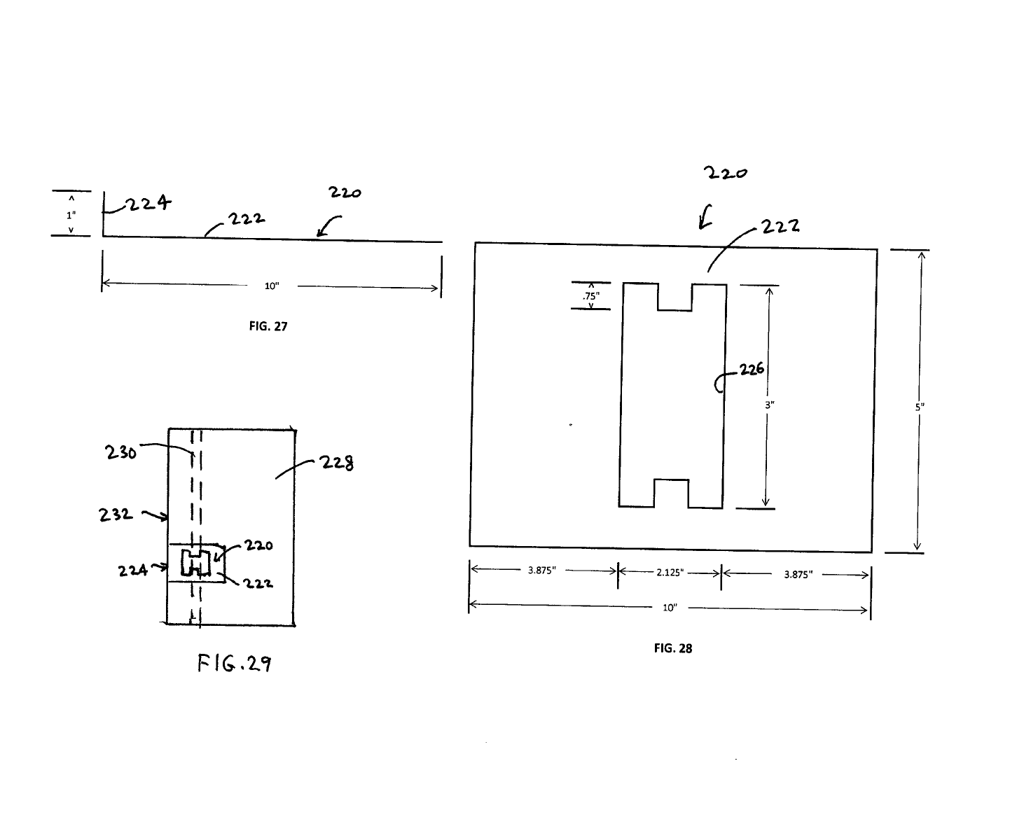

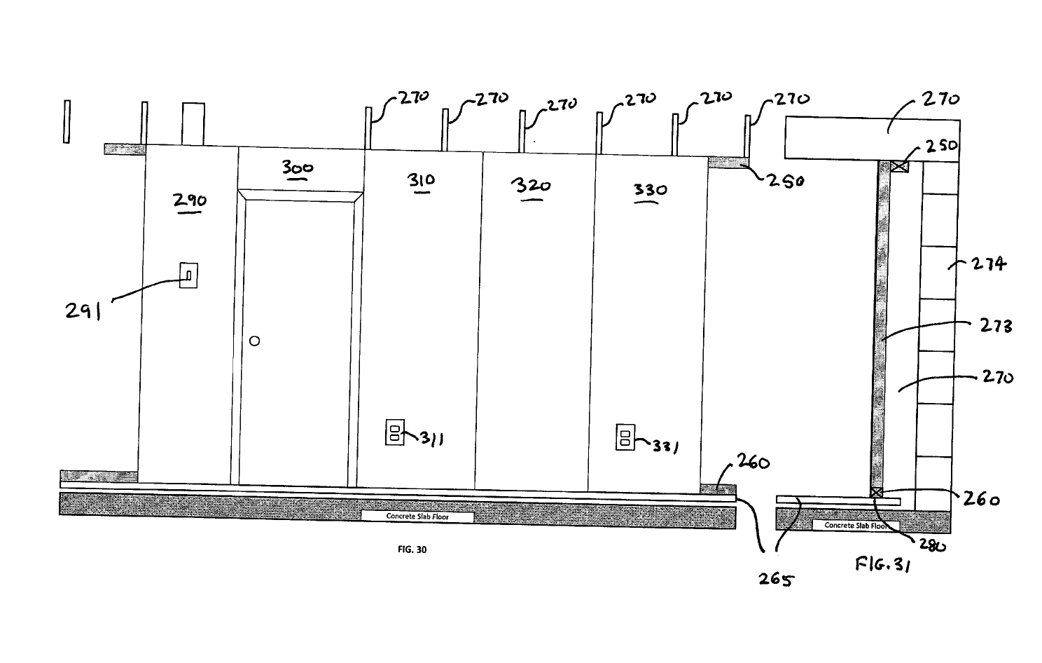

In another embodiment, in the panel 120, the conduits 142, 144, 146, and 148 are housed in a sheet of foam insulation 150. FIG. 14 is a cross section taken along line A-A of FIG. 13 but with insulation 150 included. Panel 120 is shown in FIGS. 13, 15 and 16 without insulation 150. The insulation 150 may cover all or part of the area of sheet 124. In a further embodiment, the conduits 142, 144, 146 and 148 can be omitted and the channels formed in the insulation 150 can themselves serve as conduits.

An electrical or communications box can be located at points along any of the conduits 142, 144, 146 and 148. In order to locate a box, a suitably sized and shaped opening 160 is cut in the sheet 124 and a suitably sized and shaped well (not shown) is cut in the sheet insulation 150 to house box 162. The conduits passing through the well are also cut. For example, if box 162 is located at intersection 156, conduit 142 is severed to form two conduits 164 and 166 and conduit 148 is severed to form two conduits 168 and 170. Conduit 164 extends from an opening 172 in the box 162 to the top 174 of the panel 120. Conduit 166 extends from an opening 174 in the box 162 to near the bottom 176 of the sheet 124. Conduit 168 extends from an opening 178 in the box 162 and through the framing member 130. A conduit 170 extends from an opening 180 in the box 162 and through the framing member 132.

Once the well is cut, an electrical or communications box may then be inserted into the well. The electrical or communications outlet includes an electrical outlet, electrical switch, cable box, telephone jack, internet jack, and the like.

The conduits 164, 166, 168, and 170 allow for the installation of wiring for wiring an electrical or communications outlet housed in the box 162.

A modular wall panel according to another embodiment of the present invention is generally illustrated by reference 180. The wall panel 180 is referred to as a “door header panel” when the panel is installed above a door in an interior wall. The panel 180 comprises a sheet 182 of MDF having an outer wall finishing surface 186 and an interior surface 188. The sheet 184 is 38 inches wide and 16 inches tall but may be of other dimensions depending upon the application. The sheet 184 may be made of other material suitable for forming an interior wall, such as but not limited to gypsum wallboard, shiplap, HDF, OSB, fibre cement board or drywall. gypsum wallboard and drywall. The wall finishing surface 186 is one which is suitable for accepting wall finishes such as wallpaper and paint. The surface 186 may be pre-primed such that once installed, it can be painted without further priming.

Two framing members 190 and 192 are secured to the panel 180 on the interior surface 188 side of the sheet 182. The framing members 190 and 192 may be secured to the sheet 182 by suitable adhesives and fasteners. The framing member 190 is at one end of the sheet 182. The framing member 192 is located at an interior location of the sheet 182 but may be placed at another location where it can impart sufficient structural integrity to the sheet 182. The framing members 190 and 192 are 2′×3′ wood lumber and extend from the width of the sheet 182. The framing members in certain embodiments can extend less than the width of the sheet 182. The framing members 190 and 192 may be made from other materials such as metals, alloys, composites and plastics that provide sufficient structural integrity to the panel 180. The framing member 190 is provided with a groove 194 while the framing member 192 is optionally provided with a tongue 196. The groove 194 is for receiving a tongue from another panel while the tongue 196 is designed to be received by a groove in another panel when more than one panel according to the present invention is joined together to form a wall or part of a wall. Instead of tongue and groove, other suitable connectors, such as a click-lock system, may be provided in the framing members 190 and 192 for connecting panel 180 to one or more other panels.

A third framing member 198 is provided. The third member 198 is not initially attached to the sheet 182 and may be provided with the sheet 182 as a kit. If the full width of the panel 180 is to be used, the third member 198 is affixed at the end of the sheet 182 opposite to the end where framing member 190 is located. If the panel 180 is to be less than the full width of the sheet 182, (for example a width less than full 38″ width in the embodiment shown in FIGS. 22 and 24), the third member 198 is affixed at a location on the sheet 182 closer to the member 190. Cut lines 200 may be provided on the interior surface 188, such as at 26″, 28″, 30″ and 32″along the width of the sheet 182 (as measured from the end of the sheet 182 where the framing member 190 is located). The sheet 182 can be cut along one of the cut lines 200 according to the width of the panel desired. The third member 198 is then affixed along the cut line where the sheet 182 has been cut. The member 198 is provided with a tongue 202 designed to be received by a groove in another panel when the panel 180 is to be joined to another panel on the end where third member 198 is located.

The panel 180 may be provided with insulation 204. The insulation can be any insulation suitable for residential or commercial construction to insulate. Examples of insulation which can be used include sheet foam insulation (for example be of Styrofoam™) and fibre glass insulation (for example Fiberglass Pink™). In certain embodiments, the insulation may be secured to the sheet 182 and/or to the members 190 and 192 and/or retained in place by other suitable means such as by a sheet of plastic vapour barrier material or other suitable material secured to the back of the panel 180.

Insulation can be omitted from modular wall panels according to certain embodiments of the present invention.

Framing members can be omitted from modular wall panels according to certain embodiments of the invention if the sheet used in the panel has sufficient structural integrity to be installed without the need for framing members to provide additional structural integrity. In such embodiments, the modular wall panels have connector means associated with the panels that are attached to the sheets by means other than framing members.

Sheets of wall finishing material according to certain embodiments of the present invention may optionally have a bevel on one or both side edges of the sheet. A sheet 210 of material suitable for forming an interior wall 210 is 3 mm in thickness and 24″ in width and 96 inches in height. A first bevel 212 is located at an edge of the sheet 210 of the outer wall finishing surface 214. The bevel is formed at a 45 degree angle but bevels at other suitable angles are possible. A second bevel 216 is located at the edge of the sheet 210 opposite the edge in which the bevel 212 is formed. Once sheets 210 are joined together to connect the two sheets (such as for installation), the small groove 218 created by two abutting bevelled edges can be caulked with silicone, or similar type of paintable caulking, and then troweled smooth as an alternative to the taping, filling and sanding of seems between panels of traditional gypsum wall sheet installations.

Panels according to certain embodiments of the present invention may include one or more level bubbles. One level bubble may be located in a side edge of the panel for vertical positioning (see for example 219 in FIG. 1). A level bubble may be located on the front face of the panel for horizontal positioning (see for example 221 in FIG. 1). Level bubbles may be embedded in the panel as long as they are still visible for reading.

As discussed above, wall panels according to certain embodiments of the present invention, have conduits pre-installed but do not have a well for an electrical or communications box. In order to cut an opening in sheets of wall material, a template may be used such as the template indicate by reference 220. The template 220 is made of a material that is resistant to wear from a saw blade running inside or along side the template. The template has a plate 222 and a flange 224 at right angles to the plate 222. The plate 222 includes an H-shaped opening 226 which is dimensioned to correspond to size of an opening for a standard electrical or communications box. The template 222 and the opening 226 may be of other shapes and sizes depending upon the application.

In use, in order to cut an opening in a sheet of material suitable for forming an interior wall 228, having conduit 230, the template 222 is positioned such that the flange 224 abuts the side 232 of the sheet 228. A saw such as a jig saw is used to cut out an opening in the sheet 228 by cutting along the inside edges of the H-shaped opening 226.

A series of wall panels according to certain embodiments of the present invention may be joined together to form an interior wall of a basement. The interior wall could equally be in another area of a dwelling or commercial building. The panels are installed against 2×3 cleats 250 and 260 that are fastened to the bottom of floor joists 270 at the top of the wall and to a subfloor system 265 of the basement. The top cleat 250 may be installed first against floor joists 270 and the bottom cleat 260 is then installed offset from the top cleat to accommodate the notch 280 at the bottom of each floor panel. Once the cleats 250 and 260 are installed, one determines which type of panel is required and where, and installation can proceed beginning in a corner of the basement. For walls that require plumbing installation as well, the cavity 272 created behind the wall 273 formed by the panel system and the exterior wall 274 of a dwelling or commercial building, allows for the pre-installation of all plumbing required. Once the plumbing is installed, the wall panels 290, 300, 310, 320 and 330 may be installed. The wall panels 290, 300, 310, 320 and 330 are preferably installed before the ceiling is installed enabling electrical installation to be completed after installation of the wall panels but prior to the installation of the ceiling.

Typically the wall panels 290, 300, 310, 320 and 330 would be installed before the ceiling enabling electrical installation to be completed after installation of the wall panels and before the ceiling.

Wall panel 290 is a light switch panel with light switch 291 installed, panel 300 is a door header panel, panel 310 is an outlet or cable panel with outlet 311 installed, panel 320 is a plain wall panel and panel 330 is a second outlet panel with outlet 331 installed, all according to certain embodiments of the present invention. The panels 290, 200, 310, 320 and 330 are joined together using the tongues and grooves (not shown) provided with the panels 290, 200, 310, 320 and 330.

Panels according to embodiments of the present invention can also be configured to be installed with and to accept vertical cleats.

In further embodiments, panels according to the present invention may include rigid foam with channels and optionally conduits.

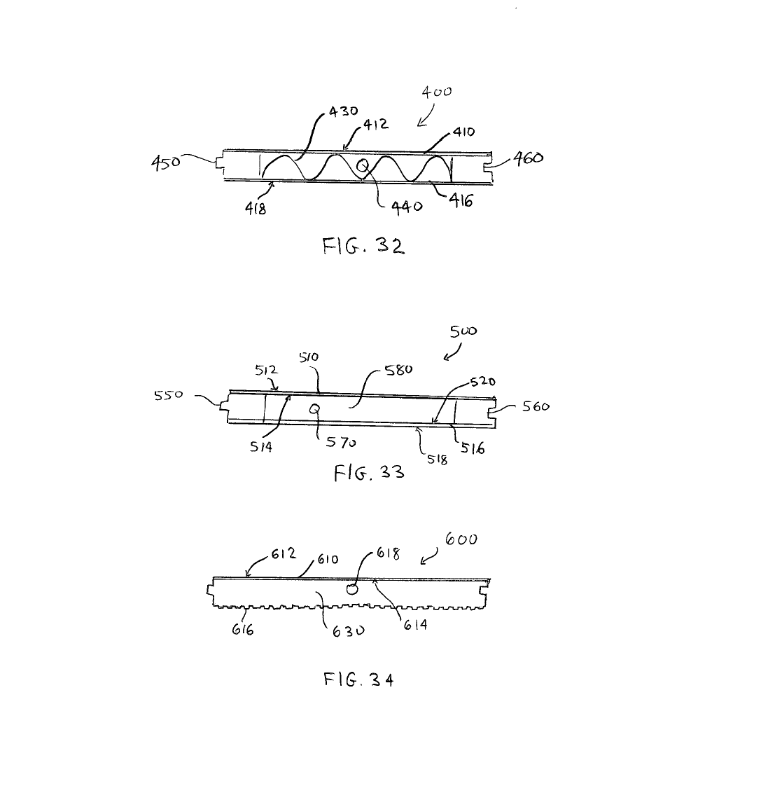

In other embodiments, in place of a rigid or solid foam, such as used for foam sheets 30, 66, 100, 150, 204, can be replaced with a non-solid structure such as a corrugated structure, a honeycomb structure and the like, or a combination of such structures. An exemplary embodiment of such a structure is shown in FIG. 32 which depicts a panel indicated generally at 400 which includes a first sheet of outer wall finishing material 410 having an outer finishing surface 412 and an inner surface 414 and a second sheet of outer wall finishing material 416 having an outer finishing surface 418 and an inner surface 420. The sheets 410 and 416 may be made of wall board, but may be made of other material suitable for forming an interior wall, such as but not limited to gypsum wallboard, shiplap, HDF, OSB, fibre cement board or drywall. The interior of the panel 400 includes a corrugated structure 430. The corrugated structure 430 is secured to the sheets 410 and 416. A channel 440 is located in the panel 400 and passes through the corrugated structure 430. Additional channels can be included in the panel 400. The channel 440 can be lined with a conduit (not shown). The panel 400 includes tongue 450 and groove 460 connectors but other connectors may be substituted therefore or the connectors omitted altogether. Such a wall panel may be used for example as an inner interior wall panel, i.e one which is not used for finishing the inside of an exterior wall.

In panels according to certain embodiments of the present invention, the framing members can be omitted. The tongue and groove or other type of connectors can be integrated into the foam sheet of the panel. For example a wall panel according to another embodiment of the present invention is illustrated by reference to FIG. 33. The panel indicated generally at 500 includes a first sheet 510 of MDF having an outer wall finishing surface 512 and an interior surface 514 and a second sheet 516 of MDF having an outer wall finishing surface 518 and an interior surface 520. The sheets 510 and 516 are 24″ wide and 96″ high but may be of other dimensions depending upon the application. The sheets 510 and 516 may be made of other material suitable for forming an interior wall, such as gypsum, wallboard, shiplap, HDF, OSB, fibre cement and drywall. The wall finishing surfaces 512 and 518 are ones which are suitable for accepting wall finishes such as wallpaper and paint. The surfaces 512 and 518 may be pre-primed such that once installed, it can be painted without further priming. Between the sheets 510 and 516 is sheet foam 580 or other suitable material.

The panel 500 includes tongue 550 and groove 560 connectors but other connectors may be substituted therefore or the connectors omitted altogether. A channel 570 may be included in the panel 500. Such a wall panel may be used for example as an inner interior wall panel, i.e one which is not used for finishing the inside of an exterior wall.

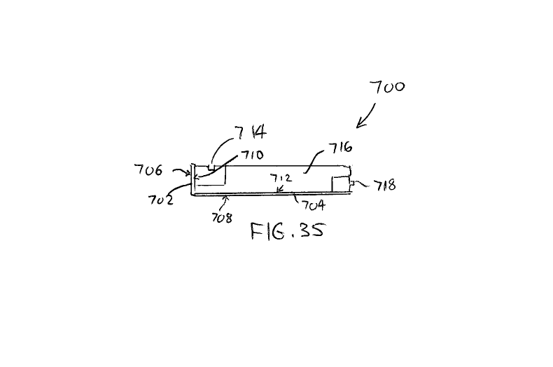

In other embodiments, sheet foam material used in certain embodiments of the present invention can have a dimpled outer surface. For example a wall panel according to another embodiment of the present invention is illustrated by reference to FIG. 34. The panel indicated by reference 600 includes a sheet 610 of MDF having an outer wall finishing surface 612 and an interior surface 614. The sheet is 24″ wide and 96″ high but may be of other dimensions depending upon the application. The sheet 610 may be made of other material suitable for forming an interior wall, such as gypsum, wallboard, shiplap, HDF, OSB, fibre cement and drywall. The wall finishing surface 612 is one which is suitable for accepting wall finishes such as wallpaper and paint. The surface may be pre-primed such that once installed, it can be painted without further priming. A rigid foam 630 is attached to the interior surface 614 and includes dimples 616.

In other embodiments of the present invention, the position of channels or conduits as the case may be in the panels may be marked on finishing surfaces according to the present invention by for example chalk lines, such as dashed lines. Chalk is preferred because it can be easily erased or painted over. Alternatively, the lines may be sprayed on or applied as a peel coat.

A panel according to another embodiment of the present invention may be used as a corner piece in a wall. For example, a wall panel indicated by reference numeral 700 according to another embodiment of the present invention is illustrated by reference to FIG. 35. The panel 700 includes outer sheets 702 and 704 of MDF having an outer wall finishing surfaces 706 and 708 and interior surfaces 710 and 712. The sheets 702 and 704 may be made of other material suitable for forming an interior wall, such as gypsum, wallboard, shiplap, HDF, OSB, fibre cement and drywall. The wall finishing surfaces 706 and 708 are suitable for accepting wall finishes such as wallpaper and paint. The surface may be pre-primed such that once installed, it can be painted without further priming. Groove 714 is formed in the sheet 716 of foam material or the like attached to the sheets 702 and 704 and tongue 718 is formed of the sheet 716. Alternatively, a member with a groove and a member with a tongue way be recessed within the sheet 716. One or more channels (not shown) may be formed in the sheet. The channels may be lined with conduits.

The above invention is described in an illustrative rather than a restrictive sense. Deviation from the exact arrangements and dimensions described may be apparent to persons skilled in the art in adapting the above invention to specific applications. Accordingly, the scope of the invention is defined by the claims set out below.

What is claimed:

1. A modular wall panel comprising:
a sheet of material suitable for forming at least part of an interior wall, the sheet having an outer face and an inner face;
a layer of insulation secured to the sheet on the inner face; and
connectors for connecting the panel to one or two other panels.

2. The modular wall panel according to claim 1 further comprising at least two framing members.

3. The modular wall panel according to claim 2 wherein the connectors are provided in the framing members.

4. The modular wall panel according to claim 1 wherein the connectors are selected from the group consisting of tongue and groove and click lock.

5. The modular panel according to claim 1 further comprising a conduit for wiring.

6. The modular panel according to claim 5 wherein the conduit is a tube.

7. The modular panel according to claim 5 wherein the conduit is located in the insulation.

8. The modular panel according to claim 7 wherein the insulation is foam insulation.

9. The modular panel according to claim 7 wherein the conduit is housed in a channel formed in the insulation.

10. The modular panel according to claim 1 further comprising one or more electrical or communications outlets.

11. The modular panel according to claim 6 wherein the panel is selected from the group consisting of a light switch panel, an outlet or cable panel, a door header panel and a plain wall panel.

12. A modular wall system comprising two or more panels comprising
a sheet of material suitable for forming at least part of an interior wall, the sheet having an outer face and an inner face;
a layer of insulation secured to the sheet on the inner face; and
connectors for connecting the panel to one or two other panels.

13. The modular wall system according to claim 12 further comprising at least two framing members.

14. The modular wall system according to claim 13 wherein the connectors are provided in the framing members.

15. The modular wall system according to claim 12 wherein the connectors are selected from the group consisting of tongue and groove and click lock.

16. The modular wall system according to claim 12 further comprising a conduit for wiring.

17. The modular wall system according to claim 16 wherein the conduit is a tube.

18. The modular wall system according to claim 16 wherein the conduit is located in the insulation.

19. The modular wall system according to claim 18 wherein the insulation is foam insulation.

20. The modular wall system according to claim 19 wherein the conduit is housed in a channel formed in the insulation.

21. The modular wall system according to claim 12 further comprising one or more electrical or communications outlets in at least one panel.

22. The modular wall system according to claim 12 wherein the panels are selected from the group consisting of a light switch panel, an outlet or cable panel, a header panel and a plain wall panel.

23. The modular wall panel according to claim 1 further comprising a level bubble.

24. The modular wall panel according to claim 1 wherein at least one edge of the panel further comprises a bevel.

25. A template comprising:
a plate comprising an opening in the plate for tracing the outline of an opening for a well in a modular wall panel; and
a flange at one end of the plate and in a plane perpendicular to the plane of the plate.
